(19) United States
(12) Patent Application Publication
(10) Pub. No.: US 2024/0151938 A1
(43) Pub. Date: May 9, 2024

(54) OPTICAL SYSTEM AND CAMERA MODULE COMPRISING SAME

(71) Applicant: LG INNOTEK CO., LTD., Seoul (KR)

(72) Inventors: Eun Sung SEO, Seoul (KR); Young Seop MOON, Seoul (KR); Jung Goo JI, Seoul (KR)

(21) Appl. No.: 18/548,121

(22) PCT Filed: Feb. 25, 2022
(86) PCT No.: PCT/KR2022/002777

§ 371 Date: Aug. 28, 2023

(30) Foreign Application Priority Data
Feb. 26, 2021 (KR) 10-2021-0026940

(51) Int. Cl. G02B 9/60; G02B 9/62; G02B 27/64

(52) U.S. Cl. CPC G02B 9/60; G02B 9/62; G02B 27/646

(57) ABSTRACT

The optical system disclosed in the embodiment of the invention includes a plurality of lenses arranged in the direction from the object side to the sensor side, wherein at least one first lens of the plurality of lenses includes a first surface that is an object-side surface and a second surface that is a sensor-side surface, a length in a first direction of the first surface is different from a length in the first direction of the second surface, the length in the first direction of the first surface is shorter than a length in a second direction of the first surface, the first direction is orthogonal to an optical axis of the lenses, and the second direction is perpendicular to the first direction and the optical axis.

### TECHNICAL FIELD

An embodiment of the invention relates to an optical system and a camera module having the same.

### BACKGROUND ART

The camera module captures an object and stores it as an image or video, and is installed in various applications. In particular, the camera module is produced in a very small size and is applied to not only portable devices such as smartphones, tablet PCs, and laptops, but also drones and vehicles to provide various functions. For example, the optical system of the camera module may include an imaging lens for forming an image, and an image sensor for converting the formed image into an electrical signal. In this case, the camera module may perform an autofocus (AF) function of aligning the focal lengths of the lenses by automatically adjusting the distance between the image sensor and the imaging lens, and may perform a zooning function of zooming up or zooning out by increasing or decreasing the magnification of a remote object through a zoom lens.

The camera module employs an image stabilization (IS) technology to correct or prevent image stabilization due to an unstable fixing device or a camera movement caused by a user's movement. The most important element for this camera module to obtain an image is an imaging lens that forms an image. Recently, interest in high performance such as high image quality and high resolution is increasing, and research on an optical system including a plurality of lenses is being conducted in order to realize this. For example, research using a plurality of imaging lenses having positive (+) and/or negative (−) refractive power to implement a high-performance optical system is being conducted. However, when a plurality of lenses is included, the entire optical system may increase, and it is difficult to derive excellent optical and aberration characteristics.

### DISCLOSURE

### Technical Problem

In an embodiment of the invention, at least one of the plurality of lenses may provide an optical system in which any one of an object-side first surface and a sensor-side second surface is non-circular shape. In an embodiment of the invention, at least one of the plurality of lenses may provide an optical system in which lengths in first and second directions perpendicular to an optical axis are different from one of an object-side first surface and a sensor-side second surface. In an embodiment of the invention, at least one of the plurality of lenses may provide an optical system in which one side or both side surfaces in the second direction have an inclination with respect to the optical axis. In an embodiment of the invention, at least one of the plurality of lenses may provide an optical system having both inclined sides. An embodiment of the invention may provide a camera module having the optical system and a portable terminal having the same.

### Technical Solution

An optical system according to an embodiment of the invention includes a plurality of lenses arranged in a sensor side direction from an object side, wherein at least one first lens of the plurality of lenses includes a first surface that is an object-side surface and a second surface that is a sensor-side surface, wherein a length in a first direction of the first surface is different from a length in the first direction of the second surface, the length in the first direction of the first surface is shorter than a length in a second direction of the first surface, the first direction is orthogonal to the optical axes of the lenses, and the second direction is perpendicular to the first direction and the optical axis.

According to an embodiment of the invention, the first lens may be the lens closest to the object side among the plurality of lenses. The first lens may be a lens closest to the sensor side among the plurality of lenses. The length of the first surface in the first direction may be shorter than a length of the second surface in the first direction. The first lens may include first and second sides on both sides in the first direction, and at least one of the first and second sides may have an inclination with respect to an optical axis.

According to an embodiment of the invention, an angle between at least one of the first side and the second side and the optical axis may be 5 to 10 degrees. The inclinations of the first side and the second side may be equal to each other. A length of the first surface in the second direction may be the same as a length of the second surface in the first direction. A length of the first surface in the first direction may be longer than a length of the second surface in the first direction. A radius of curvature of the first surface in the optical axis may be greater than a radius of curvature of the second surface in the optical axis.

### Advantageous Effects

According to an embodiment of the invention, since an inclined side surface is formed on the outside of at least one of the lenses in the camera module, it is possible to reduce the problem that unnecessary light (i.e., miscellaneous light) is condensed on the image sensor or the size of the light increases. According to an embodiment of the invention, one or a plurality of inclined side surfaces are provided on the outer side surface of at least one lens close to the object, so that the size of miscellaneous light may be reduced by changing the path of some incident light. According to an embodiment of the invention, at least one lens close to the object is provided with different lengths in the first and second directions of any one of the first and second surfaces on which light is incident and exited, so that the size of miscellaneous light condensed by the sensor may be reduced by changing the path of some incident light. According to an embodiment of the invention, it is possible to provide a narrow-angle optical system. According to an embodiment of the invention, it is possible to implement a high-resolution narrow-angle camera module.

### DESCRIPTION OF DRAWINGS

FIG. 1 is an example of a cross-sectional side view of an optical system according to an embodiment of the invention.

FIG. 2 is a view of a first lens in the optical system of FIG. 1.

FIG. 3 is a perspective view of the first lens of FIG. 2.

FIG. 4 is a side view of the first lens of FIG. 3.

FIG. 5(A)(B) is examples of plan views showing the first surface and the second surface of the first lens of FIG. 2.

FIG. 6(A)(B) is side views viewed from the first direction Y and the second direction X with respect to the first lens of FIG. 5.

FIG. 7(A)(B) is a first modified example of the first lens of FIG. 2, and are other examples of an inclined side surface viewed in the first direction Y.

FIG. 8 is a second modified example of the first lens of FIG. 2, and is a side view viewed in the first direction Y.

FIG. 9 is a third modified example of the first lens of FIG. 2, and is a side view viewed in the first direction Y.

FIG. 10 is a side view of the fourth modified example of the first lens of FIG. 2, and is a side view viewed in the first direction Y.

FIG. 11 is a side view of the fifth modified example of the first lens of FIG. 2, and is a side view viewed in the first direction Y.

FIG. 12(A)(B) is a sixth modified example of the first lens of FIG. 2, in which both sides viewed in the first direction Y are different.

FIG. 13(A)(B) is another example of FIG. 12, in which both sides viewed in the first direction Y are different.

FIG. 14(A)(B) is diagrams for explaining a light path incident to the side surface of the first lens as a comparative example and an embodiment of the invention.

FIG. 15 is another example of the first lens in the optical system of FIG. 2.

FIG. 16(A)(B) is plan views of the first and second surfaces of the first lens of FIG. 15 as viewed from the object side and the sensor side.

FIG. 17 is a side view of the first lens of FIG. 15 as viewed in the first direction Y.

FIG. 18 is another example of a side view of the first lens of FIG. 15 viewed in the first direction Y.

FIG. 19 is another example of the first lens in the optical system of FIG. 2.

FIG. 20(A)(B) is views for explaining an optical path according to a shape change of the second surface of the first lens according to an embodiment of the invention.

FIG. 21(A)(B)(C) is a view comparing the path of the incident light according to the side shape of the first lens according to an embodiment of the invention.

FIG. 22 is an example of a cutting line for explaining the inclined side of the first lens in the optical system according to an embodiment of the invention.

FIG. 23(A)(B) is other examples of plan views illustrating the first and second surfaces of the first lens of FIG. 2 or FIG. 5.

FIG. 24 is a view for explaining the degree of change in resolution according to the inclined angle of the side surface of the first lens in the optical system according to an embodiment of the invention.

FIG. 25 is a diagram illustrating a location of miscellaneous light in an image sensor according to an embodiment of the invention.

FIG. 26 is a diagram comparing the position and size of a flare formed on an image sensor according to a side inclination angle of a first lens in an optical system according to an embodiment of the invention.

FIGS. 27 and 28 are views illustrating a flare distribution and irradiance formed on an image sensor in an optical system according to a comparative example and an embodiment of the invention.

FIG. 29 is a perspective view of a portable terminal having an optical system according to an embodiment of the invention.

### BEST MODE

Hereinafter, preferred embodiments of the invention will be described in detail with reference to the accompanying drawings. A technical spirit of the invention is not limited to some embodiments to be described, and may be implemented in various other forms, and one or more of the components may be selectively combined and substituted for use within the scope of the technical spirit of the invention. In addition, the terms (including technical and scientific terms) used in the embodiments of the invention, unless specifically defined and described explicitly, may be interpreted in a meaning that may be generally understood by those having ordinary skill in the art to which the invention pertains, and terms that are commonly used such as terms defined in a dictionary should be able to interpret their meanings in consideration of the contextual meaning of the relevant technology. Further, the terms used in the embodiments of the invention are for explaining the embodiments and are not intended to limit the invention. In this specification, the singular forms also may include plural forms unless otherwise specifically stated in a phrase, and in the case in which at least one (or one or more) of A and (and) B, C is stated, it may include one or more of all combinations that may be combined with A, B, and C. In describing the components of the embodiments of the invention, terms such as first, second, A, B, (a), and (b) may be used. Such terms are only for distinguishing the component from other component, and may not be determined by the term by the nature, sequence or procedure etc. of the corresponding constituent element. And when it is described that a component is “connected”, “coupled” or “joined” to another component, the description may include not only being directly connected, coupled or joined to the other component but also being “connected”, “coupled” or “joined” by another component between the component and the other component. In addition, in the case of being described as being formed or disposed “above (on)” or “below (under)” of each component, the description includes not only when two components are in direct contact with each other, but also when one or more other components are formed or disposed between the two components. In addition, when expressed as “above (on)” or “below (under)”, it may refer to a downward direction as well as an upward direction with respect to one element. Several embodiments described below may be combined with each other, unless it is specifically stated that they cannot be combined with each other. In addition, the description of other embodiments may be applied to parts omitted from the description of any one of several embodiments unless otherwise specified.

In the description of the invention, the first lens means the lens closest to the object side among the plurality of lenses aligned with the optical axis, and the last lens means the lens closest to the sensor side among the plurality of lenses aligned with the optical axis. In the description of the invention, all measures for the radius, thickness/distance, TTL, etc. of the lens are mm unless otherwise specified. In the present specification, the shape of the lens is shown based on the optical axis of the lens. For example, that the object-side or sensor-side surface of the lens is convex means that the optical axis vicinity is convex on the object-side or sensor-side surface of the lens, but does not mean that the optical axis periphery is convex. Accordingly, even when the object-side or sensor-side surface of the lens is described as being convex, the portion around the optical axis on the object-side or sensor-side surface of the lens may be concave. That the object-side or sensor-side surface of the lens is concave means that the vicinity of the optical axis is concave on the object-side or sensor-side surface of the lens, but does not mean that the periphery of the optical axis is concave. Accordingly, even when the object-side or sensor-side surface of the lens is described as being concave, the portion around the optical axis on the object-side or sensor-side surface of the lens may be convex. In the present specification, it should be noted that the thickness and radius of curvature of the lens are measured based on the optical axis of the lens. In addition, “object side” may mean the surface of the lens that faces the object side with respect to the optical axis, and “sensor side” may mean the surface of the lens that faces the imaging plane or image sensor with respect to the optical axis, or faces opposite to the face of the object. The optical system according to an embodiment of the invention may include a lens made of a glass material and/or a lens made of a plastic material.

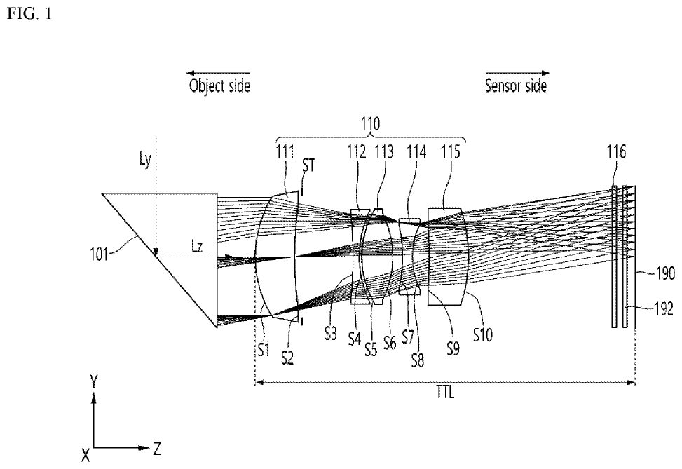

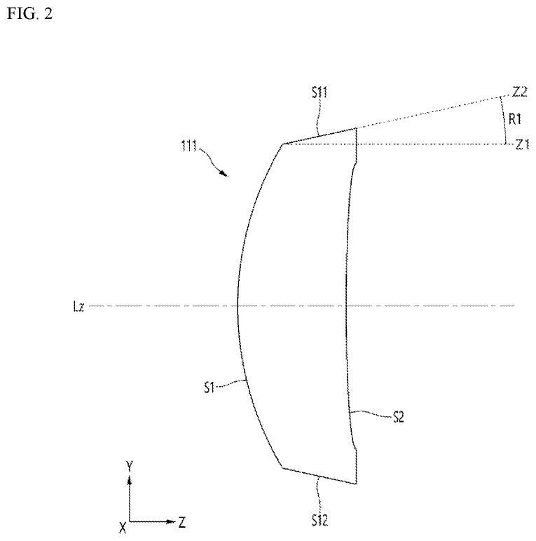

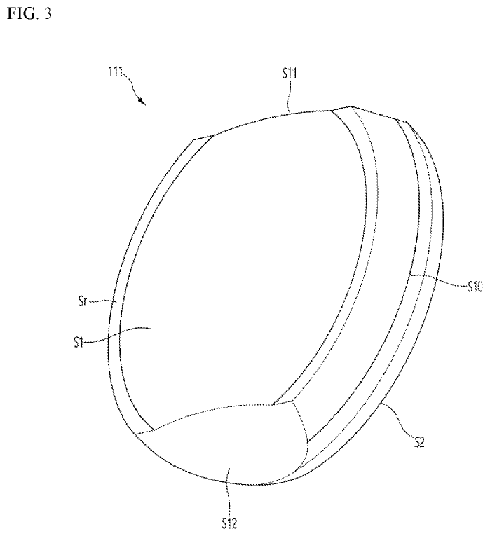

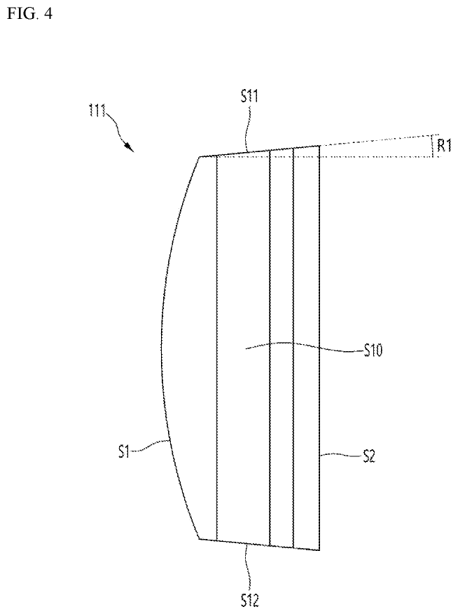

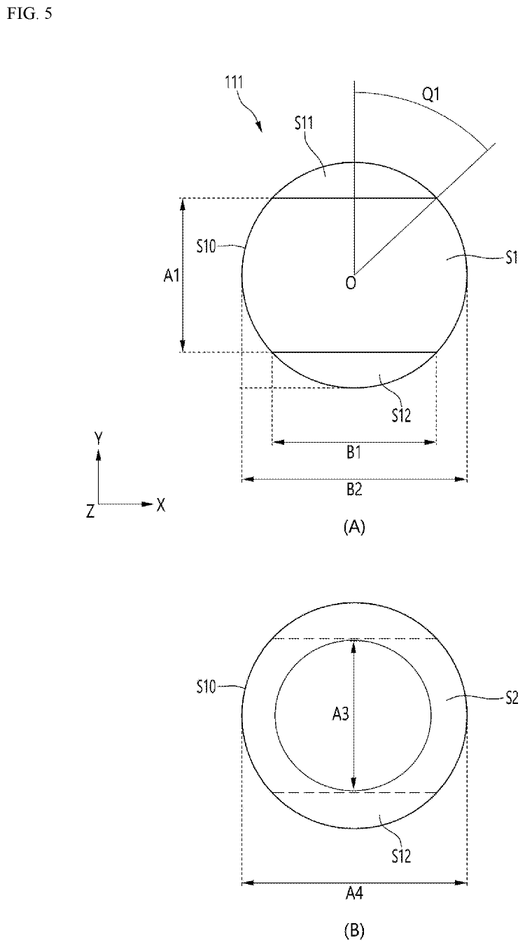

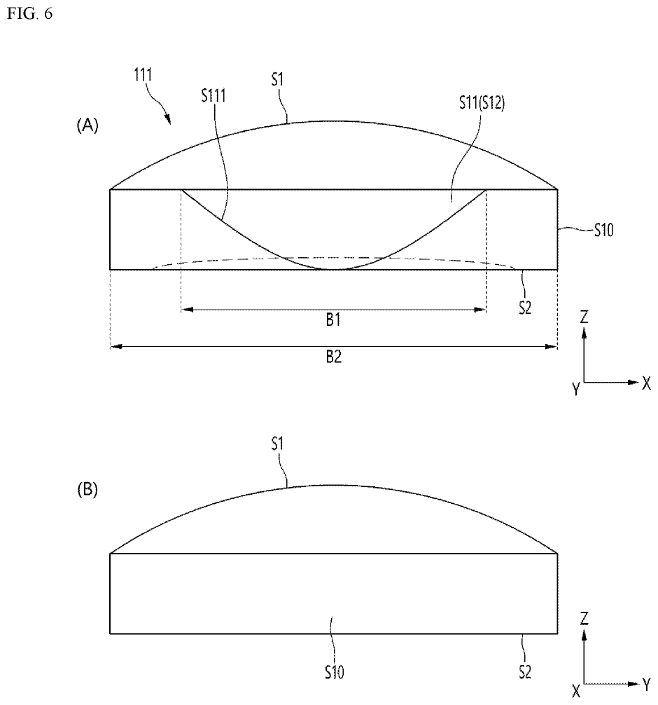

Hereinafter, an optical system according to an embodiment of the invention will be described. 1 is an example of a cross-sectional side view of an optical system according to an embodiment of the invention, FIG. 2 is a view of a first lens in the optical system of FIG. 1, FIG. 3 is a perspective view of the first lens of FIG. 2, FIG. 4 is a side view of the first lens of FIG. 3, FIG. 5 (A)(B) is a plan view viewed from the first and second surfaces of the first lens of FIG. 2, and FIG. 6(A)(B) is a side view viewed from the first direction Y and the second direction X with respect to the first lens in FIG. 5.

Referring to FIGS. 1 to 6, an optical system according to an embodiment of the invention may include an optical system having four or more lenses or five or more lenses. The optical system may include a lens unit 110 having five lenses 111, 112, 113, 114, and 115 or six lenses 111,112,113,114,115, and 116 stacked from the object side toward the image sensor 190. The lens unit 110 may be aligned along the optical axis Lz from the first lens 111 closest to the object side to the fifth lens 115 or the sixth lens 116. Here, the first direction Y orthogonal to the optical axis Lz direction Z is the height of the camera module, a thickness direction of the portable terminal, or a height direction of a movable body, and the second direction X is a directional perpendicular to the first direction Y and the optical axis direction Z.

The optical system may include the reflective member 101 on the object side of the first lens 111. The reflective member 101 may be implemented as a prism, and may reflect light incident in the direction of the axis Ly orthogonal to the optical axis Lz of the lens unit 110. In the optical system, another lens may be further disposed on the object side of the reflective member 101. In the optical system, the optical axis Lz of the lens unit 110 and the center of the image sensor 190 may be disposed on the same axis or may be aligned on different axes. In this case, when the optical axis Lz of the lens unit 110 and the center of the image sensor 190 are disposed on different axes, another reflective member may be further disposed between the lens unit 110 and the image sensor 190. In the optical system, one of at least two first lens groups close to the object side and at least two second lens groups close to the sensor side may be moved in the optical axis direction Z. For example, one of a first lens group of the first, second, and third lenses 111, 112, and 113 and a second lens group of the fourth, fourth, and sixth lenses 114, 115 and 116 may be moved in the optical axis direction Z. Accordingly, the optical system may implement an auto-focusing (AF) function by a lens group moving in the optical axis direction Z. An embodiment of the invention provides an optical system for focusing by moving only one lens group, thereby suppressing an increase in space or a moving distance relatively. Also, in the optical system, any one of the first lens group and the second lens group may be moved in a direction orthogonal to the optical axis for an OIS (Optical Image Stabilizer) function. The camera module may include a driving member for moving the optical system, and the driving member may be an actuator or a piezoelectric element for an AF function and/or an OIS function.

The lenses in the optical system may include lenses made of a solid material, for example, a glass material and/or a plastic material. At least one or all of the lenses 111, 112, 113, 114, and 115 may include an aspherical surface on the incident side. At least one or all of the lenses 111, 112, 113, 114 and 115 may include an aspherical surface on an object-side surface and/or a sensor-side surface. The optical system may include a diaphragm ST for adjusting the amount of incident light. The aperture ST may be disposed between any one of the first, second, and third lenses 111, 113, and 115, for example, around the sensor-side surface of the first lens 111. In the optical system, the sixth lens 116 may be a lens that does not affect optical performance, may be removed, and will be described as the center of the lens unit 110 having the first to fifth lenses 111, 112, 113, 114 and 115.

The light corresponding to the image information of the object may pass through the first lens 111, the second lens 112, the third lens 113, the fourth lens 114, the fifth lens 115, and the sixth lens 116, and the filter 192 and may be incident on the image sensor 190. Each of the first to sixth lenses 111, 112, 113, 114, 115, and 116 may include an effective region and an ineffective region. The effective region may be a region through which light incident on each lens passes. That is, the effective region may be a region in which incident light is refracted to realize optical properties. The ineffective region may be disposed around the effective region. The ineffective region may be a region to which the light is not incident. That is, the ineffective region may be a region independent of the optical characteristic. Also, the ineffective region may be a region fixed to a lens holder or a barrel (not shown) for accommodating lenses. In the optical system according to an embodiment of the invention, the effective focal length (EFL) may be 35 mm or less, for example, 10 mm to 35 mm or 13 mm to 23 mm. In the optical system, TTL (Total Top Length) may be 35 mm or less, for example, in the range of 10 mm to 25 mm or in the range of 13 mm to 23 mm. The F number of the optical system may be 4 or less, for example, in the range of 2.5 to 4 or in the range of 3 to 3.6. In the optical system, a distance to the object is at least 30 mm or more, for example, 35 mm, and may be at most infinity. In the optical system, a field of view (FOV) may be a narrow angle, for example, 50 degrees or less.

The first lens 111 may be a lens closest to the object side in the optical system or a lens closest to the reflection member 101. The first lens 111 may have positive (+) refractive power. The first lens 111 may include a glass material or a plastic material. The first lens 111 may include a first surface S1 defined as an object-side surface and a second surface S2 defined as a sensor-side surface. The first surface S1 may be an incident surface, and the second surface S2 may be an exit surface. On the optical axis Lz, the first surface S1 may be convex and the second surface S2 may be concave. That is, the first lens 111 may have a meniscus shape convex toward the object. At least one or both of the first surface S1 and the second surface S2 may be aspherical. A radius of curvature of the first surface S1 of the first lens 111 may be greater than a radius of curvature of the second surface S2 of the first lens 111. The effective diameter or effective region of the first surface S1 of the first lens 111 may be larger than the effective diameter or effective region of the second surface S2.

The effective radius of the first lens 111 may be greater than the effective radius of the second to fifth lenses 112, 113, 114, and 115 with respect to the optical axis. Accordingly, the amount of ambient light of the light focused by the image sensor 190 may be improved. The thickness of the first lens 111 on the optical axis Lz of the optical system, i.e., the central thickness, may be thicker than the central thickness of each of the second to fourth lenses 112, 113, and 114, and 1.5 mm or more, for example, in a range of 1.5 mm to 2 mm. The first lens 111 may have a relatively thick thickness and a large effective diameter, and may refract the amount of incident light to focus the light onto the second lens 112.

The first lens 111 may provide side surfaces S11 and S12 in which the height direction (i.e., Y) of the camera module is cut. The cut side surface may be either or both sides of the first lens 111 in the first direction Y, and may provide a surface that is not parallel to the optical axis. The cut side surfaces S11 and S12 may be outer surfaces in which a portion of the effective diameter is cut in the optical axis direction from one side or both sides of the first lens 111 in the first direction Y. As a first example, a portion of the cut effective diameter may be one or both sides of the first surface S1, and one or both sides of the second surface S2 may be cut with rib or flange without cutting the effective diameter. As another second example, a portion of the cut effective diameter may be one or both sides of the second surface S2, and one or both sides of the first surface S1 may be cut with rib or flange without cutting the effective diameter. One of the first and second surfaces S1 and S2 of the first lens 111 may have a non-circular shape, and the other may have a circular shape. For example, the first surface S1 may be non-circular, and the second surface S2 may have a circular shape. Conversely, the second surface S2 may be non-circular, and the first surface S1 may have a circular shape. Any one or both of the first and second side surfaces S11 and S12 of the first lens 111 may have an inclination with respect to the optical axis. The slope may be the same as or different from the first and second side surfaces S11 and S12.

As shown in FIGS. 5 (A) (B) and 6, a length A1 of the first direction Y of the object-side first surface S1 in the first lens 111 may be smaller than a length B2 in the second direction X. In the first lens 111, a length A4 in the first direction Y of the sensor-side second surface S2 may be the same as or smaller than the length in the second direction X, may be greater than an effective diameter A3 of the second surface S2, and may be the same as the diameter (e.g., B2) of the first surface S1. For example, the length A1 of the object-side first surface S1 in the first direction Y is the length of the effective diameter of the first surface S1, and may be smaller than the length B2 in the second direction X. The length A4 of the sensor-side second surface S2 in the first and second directions Y and X may be the same as the length including the ribs. In the first lens 111, the effective diameter in the first and second directions Y and X of the object-side first surface S1 and in the first and second directions Y and X of the sensor-side second surface S2 may not be the same length. Here, the lengths A1 and A3 in the first direction Y are linear distances from the first and second surfaces S1 and S2 of the first lens 111 to the cut side surfaces S11 and S12. The length B2 in the second direction X may be the length of the effective diameter of the first lens 111.

The maximum length B1 in the second direction X of the side surfaces S11 and S12 cut in the first lens 111 may be smaller than the length B2 of the effective diameter of the first surface S1, and may be greater than the length A3 of the effective diameter of the second surface S2. The angle Q1 from the straight line in the first direction Y passing through the center O to the outer end of the object side of and the first and second side surfaces S11 and S12 with respect to the center O of the first lens 111 may be 60 degrees or less, for example, in the range of 30 degrees to 60 degrees, or in the range of 30 degrees to 50 degrees. The angle Q1 may indicate a position where the first and second side surfaces S11 and S12 start from the object-side surface of the first lens 111.

As shown in FIGS. 2 to 4, one end or both ends of the first surface S1 of the first lens 111 in the first direction Y is a boundary between the cut side surface and the first surface S1, and one end or both ends of the second surface S2 in the first direction Y is a boundary between the cut side surface and the second surface S2. The boundary may be an edge in the first direction Y of the first and second surfaces S1 and S2. Here, the first axis Z1 passing through one end of the first surface S1 of the first lens 111 and parallel to the optical axis may intersect a region of the effective diameter or a region of the rib of the second surface S2. The second axis Z2 passing both ends of the inclined side surfaces S11 and S12 in the first lens 111 may intersect an edge of the effective diameter of the first surface S1 in the first direction Y and an edge or a rib edge of the effective diameter of the second surface S2 in the first direction Y. That is, when the effective diameter of the second surface S2 is smaller than the effective diameter of the first surface S1, the second axis Z2 may intersect the ribs disposed outside the effective diameter of the second surface S2.

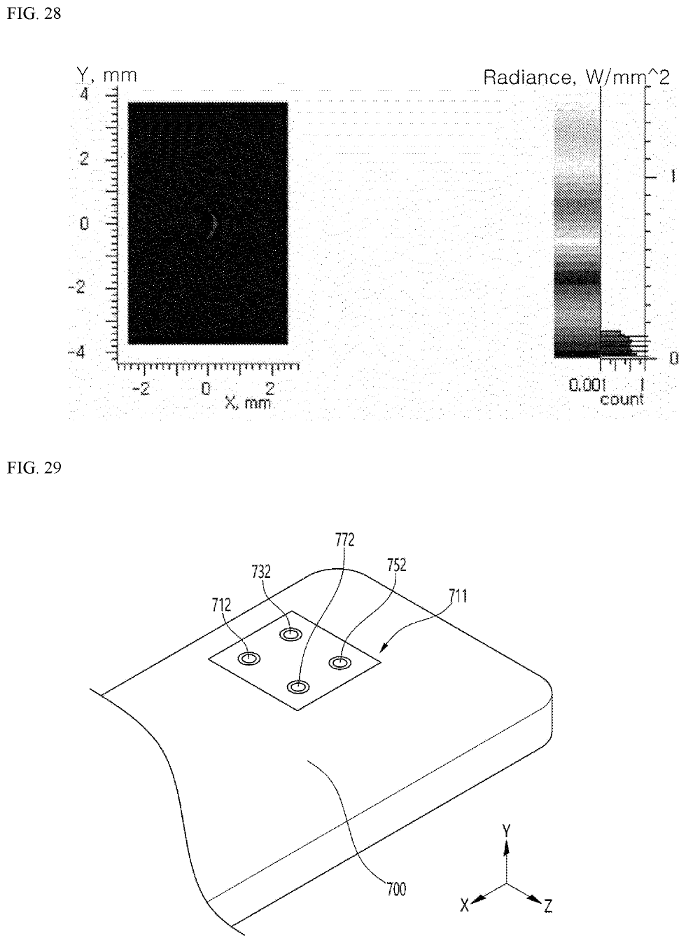

Since the inclined side surfaces S11 and S12 is formed on one or both sides of the first lens 111 in the first direction, unwanted light among the incident light is reflected by the inclined side surfaces S11 and S12, and the reflected light may travel outside the effective region, not the effective region of the second and third lenses 112 and 113. Accordingly, it is possible to reduce or suppress the problem of unwanted light being focused on the image sensor 190, thereby minimizing the size of flare on the image sensor 190. FIG. 27(A)(B) show the size and illuminance of miscellaneous light on the image sensor when both sides of the first lens in the first direction have vertically cut side surfaces in the optical system of the comparative example, and FIG. 28(A))(B) shows that when the side surfaces of the first lens of the optical system according to an embodiment of the invention are cut obliquely on both sides in the first direction, and it may be seen that the miscellaneous light on the image sensor is almost eliminated and the illuminance is uniform.

As shown in FIG. 2, the angle R1 formed by each of the inclined side surfaces S11 and S12 of the first lens 111 is an angle of the second axis Z2 with respect to the first axis Z1, and is 10 degrees or less, for example, in the range of 0.5 degrees to 10 degrees or in the range of 5 degrees to 10 degrees. When the angle R1 is greater than the above range, the lens height may not be reduced, so that the height of the camera module increases. When the angle R1 is smaller than the above range, the effect of reducing flare is insignificant. In the first lens 111, the linear distance between the first side surface S11 and the second side surface S12 inclined on both sides in the first direction Y may be the minimum distance on the first surface S1 (i.e., A1) and may be the maximum distance (i.e., A4) on the second surface S2. The minimum distance from the first surface S1 may be the length A1 of the first surface S1 in the first direction Y, and the maximum distance from the second surface S2 may be a length A4 of the second surface S2 in the first and second directions Y and X. A boundary between the second surface S2 and the first and second side surfaces S11 and S12 may be an outer edge of the second surface S2. Accordingly, the length in the first direction Y and the length A4 in the second direction X in the second surface S2 may be the same as each other. To this end, when cutting the first and second side surfaces S11 and S12, the cutting is performed from the outside of the effective diameter of the first side S1 toward the outer edge of the second side S2. Accordingly, the cut portion of the second side S2 may be minimized or absent.

A portion of the first side surface S11 of the first lens 111 may overlap a rib region outside the effective diameter of the second surface S2 of the first lens 111 in the optical axis direction. A portion of the second side surface S12 may overlap a rib region outside the effective diameter of the second surface S2 of the first lens 111 in the optical axis direction. In the first lens 111, a length A1 of the effective diameter in the first direction Y of the object-side first surface S1 may be 4.5 mm or more, for example, in a range of 4.5 mm to 5.5 mm, and a length B2 of the effective diameter length B2 in the second direction X may be 5 mm or more, for example, in the range of 5 mm to 6 mm. A length A3 of the effective diameter in the first and second directions Y and X of the sensor-side second surface S2 of the first lens 111 may be 4.1 mm or more, for example, in the range of 4.1 mm to 5.2 mm.

The second lens 112 may have a negative (−) refractive power. The second lens 112 may include a plastic material. The second lens 112 may include a third surface S3 defined as an object-side surface and a fourth surface S4 defined as a sensor-side surface. The third surface S3 may be an incident surface, and the fourth surface S4 may be an exit surface. The third surface S3 may be concave toward the sensor and the fourth surface S4 may be concave toward the object. At least one or both of the third surface S3 and the fourth surface S4 may be aspherical. The thickness of the second lens 112 on the optical axis Lz may be smaller than the thickness of the first and third lenses 111 and 113, and may be 0.6 mm or less, for example, in the range of 0.1 mm to 0.5 mm. The second lens 112 may be provided with the thinnest thickness in the lens unit 110.

The third lens 113 may have positive (+) refractive power. The refractive power value of the third lens 113 may be greater than the refractive power value of the first lens 111. The third lens 113 may include a glass or plastic material. The third lens 113 may include a fifth surface S5 defined as an object-side surface and a sixth surface S6 defined as a sensor-side surface. The fifth surface S5 may be an incident surface, and the sixth surface S6 may be an exit surface. The fifth surface S5 may be convex toward the object and the sixth surface S6 may be convex toward the sensor. At least one or both of the fifth surface S5 and the sixth surface S6 may be aspherical. The thickness of the third lens 113 on the optical axis Lz may be greater than the thickness of the second and fourth lenses 111 and 114, and may be 1.2 mm or more, for example, in the range of 1.2 mm to 1.6 mm. The thickness of the third lens 113 may be thinner than the thickness of the first lens 111, and a thickness difference between the first and second lenses 111 and 112 may be 0.5 mm or less. The third lens 113 may receive the light diffused on the concave fourth surface S4 of the second lens 112 and condense the light through the convex fifth surface S5 and the sixth surface S6.

The fourth lens 114 may have a negative refractive power. The fourth lens 114 may include a glass or plastic material. The fourth lens 114 may include a seventh surface S7 defined as an object-side surface and an eighth surface S8 defined as a sensor-side surface. The seventh surface S7 may be an incident surface, and the eighth surface S8 may be an exit surface. The seventh surface S7 may be concave toward the sensor and the eighth surface S8 may be concave toward the object. At least one or both of the seventh surface S7 and the eighth surface S8 may be aspherical. The thickness of the fourth lens 114 on the optical axis Lz may be smaller than the thickness of the third and fifth lenses 113 and 115, and may be 1 mm or less, for example, in the range of 0.2 mm to 0.9 mm. The thickness of the fourth lens 114 may be thicker than the second lens 114, and a thickness difference from the third lens 113 may be 0.9 mm or more. The fourth lens 114 may receive the light condensed by the convex sixth surface S6 of the third lens 113, and may refract the incident light to be diffused through the concave seventh and eighth surfaces S7 and S8.

The fifth lens 115 may have positive (+) refractive power. The refractive power value of the fifth lens 115 may be smaller than the refractive power value of the first lens 111. The fifth lens 115 may include a plastic material. The fifth lens 115 may include a ninth surface S9 defined as an object-side surface and a tenth surface S10 defined as a sensor-side surface. The ninth surface S9 may be an incident surface, and the tenth surface S10 may be an exit surface. The ninth surface S9 may be convex toward the sensor and the tenth surface S10 may be convex toward the sensor. At least one or both of the ninth surface S9 and the tenth surface S10 may be aspherical. The thickness of the fifth lens 115 on the optical axis Lz may be greater than the thickness of the fourth lens 114, and may be 1.5 mm or less, for example, in the range of 1.5 mm to 2 mm. The fifth lens 115 may have the same thickness as that of the first lens 111 or a thickness difference of 0.2 mm or less. The fifth lens 115 may refract the light diffused by the concave eighth surface S8 of the fourth lens 114 through the concave ninth surface S9 and the convex tenth surface S10.

The sixth lens 116 is disposed between the fifth lens 115 and the image sensor 190, may have an effective diameter larger than the effective diameter of the first lens 111, and may be a lens having the largest diameter in the optical system. The sixth lens 116 may have a radius of curvature between the object-side surface and the sensor-side surface greater than that of the first to fifth lenses 111, 112, 113, 114 and 115, and may be the largest among lenses in the optical system. The thickness of the sixth lens 116 may be thinner than the central thickness of the second lens 112 and may be 0.25 mm or less. The sixth lens 116 may be made of a glass material or a plastic material. The sixth lens 116 may be positioned closer to the image sensor 190 than the fifth lens 115. When the second lens group is a moving group, the sixth lens 116 may be moved together with the fifth lens 115 in the optical axis direction Z. The sixth lens 116 may be removed in the optical system. The sixth lens 116 may provide a surface in which the height direction (i.e., Y) of the camera module is cut. The cut surface may be any one or both of both sides of the sixth lens 116 in the first direction Y, and may provide a surface parallel to the optical axis. The cut surface may be a surface in which a portion of the effective diameter is cut from one side or both sides of the sixth lens 116 in the first direction Y toward the optical axis direction. A portion of the effective diameter cut by the sixth lens 116 may be on one side or both sides of the object-side surface, and may be on one or both sides of the sensor-side surface in the first direction.

The sixth lens 116 may be a lens closest to the image sensor, and the length of the object-side surface in the first direction Y may be different from the length in the second direction X. In the sixth lens 116, a length of the sensor-side surface in the first direction Y may be different from a length in the second direction X. In the sixth lens 116, the length of the object-side surface in the first direction Y may be smaller than the length in the second direction X. In the sixth lens 116, the length of the sensor-side surface in the first direction Y may be smaller than the length in the second direction X. In the sixth lens 116, the length of the object-side surface in the first direction Y and the length of the sensor-side surface in the first direction Y may be the same. Here, the length of the first direction Y and the length of the second direction X may be the length of the effective diameter of the sixth lens 116. The length in the first direction Y of the object-side surface in the sixth lens 116 may be in the range of 4.5 mm or more, for example, in the range of 4.5 mm to 5.5 mm, and the length in the second direction X may be 5.5 mm or more, for example, in the range of 5.5 mm to 6.5 mm. In the sixth lens 116, the length of the sensor-side surface in the first direction Y may be 4.5 mm or more, for example, in the range of 4.5 mm to 5.5 mm, and the length in the second direction X may be 5.6 mm or more, for example, in the range of 5.6 mm to 6.65 mm. Here, the lengths in the second direction X of the object-side surface and the image-side surface of the sixth lens 116 may be greater than the length in the second direction X of the first surface S1 and the second surface S2 of the first lens 111. The length in the first direction Y of the object-side surface of the sixth lens 116 may be the same as the length in the first direction Y of the first surface S1 and the second surface S2 of the first lens 111. As another example, the sixth lens 116 may have sides inclined or inclined with respect to the optical axis on one or both sides of the first direction Y, and the angles of the inclined and inclined side surface may be in a range of 5 degrees to 10 degrees.

Here, the distance between the first lens 111 and the second lens 112 on the optical axis may be the largest among the distances between the two adjacent lenses, and may be 1.5 mm or more, for example, in the range of 1.5 mm to 3 mm. In this case, the distance between the first and second lenses 111 and 112 may be a distance at which light reflected by the inclined side surfaces S11 and S12 of the first lens 111 is not incident on the effective region of the second lens 112. The distance between the first lens 111 and the second lens 112 may be greater than the central thickness of the first lens 111, and may be 1.2 times or more of the central thickness of the first lens 111, for example, in the range from 1.2 to 1.8 times. The distance between the second lens 112 and the third lens 113 may be the smallest among the distances between the two adjacent lenses, and may be 0.05 mm or less, for example, in the range of 0.05 mm to 1.2 mm. A distance between the second lens 112 and the third lens 113 may be smaller than a center thickness of the second lens 112. The minimum distance between the third lens 113 and the fourth lens 114 may be the second smallest between the two adjacent lenses, and may be 0.6 mm or less, for example, in the range of 0.35 mm to 0.6 mm. A distance between the third lens 113 and the fourth lens 114 may be greater than a distance between the second lens 112 and the third lens 113. The distance between the fourth lens 114 and the fifth lens 115 may be the second largest among the distances between two adjacent lenses, and may be 0.55 mm or more, for example, in the range of 0.55 mm to 0.85 mm. A distance between the fourth lens 114 and the fifth lens 115 may be greater than a minimum distance between the third lens 113 and the fourth lens 114.

In the optical system, the focal length of the first lens 111 has a positive value, and may be 7 mm or more, for example, in the range of 7 mm to 13 mm. The focal length of the second lens 112 has a negative value, and may be −3 mm or less, for example, in the range of −3 mm to −7 mm. The focal length of the third lens 113 has a positive value and may be 5 mm or less, for example, in the range of 1 mm to 5 mm. The focal length of the fourth lens 114 has a negative value, and may be −1 mm or less, for example, in the range of −1 mm to −5.5 mm. The focal length of the fifth lens 115 has a positive value and may be 10 mm or more, for example, in the range of 10 mm to 16 mm. When an absolute value is taken, the focal length of the fifth lens 115 may be the largest among the focal lengths of the lenses.

The optical filter 192 may include an optical filter such as an infrared filter. The optical filter 192 may pass light of a set wavelength band and filter light of a different wavelength band. The optical filter 192 may block radiant heat emitted from external light from being transmitted to the image sensor 190. In addition, the optical filter 192 may transmit visible light and reflect infrared light. The image sensor 190 may detect the light passing through the optical filter 192. The image sensor 190 may include a charge coupled device (CCD) or a complementary metal oxide semiconductor (CMOS).

At least one first lens 111 of the plurality of lenses 111, 112, 113, 114, and 115 according to an embodiment of the invention may include side surfaces S11 and S12 in which both sides or one side in the first direction Y are inclined. Alternatively, any one lens 111 closest to the object side and one lens 116 closest to the sensor among the plurality of lenses 111, 112, 113, 114, 115, 116 may each include a side inclined at both sides or one side in the first direction Y.

According to an embodiment of the invention, one or a plurality of lenses having cut side surfaces may be disposed in the optical system. The at least one lens having the cut side surface may include inclined side surfaces S11 and S12 on one side or both sides of the first direction Y, respectively. The at least one first lens 111 having the side surfaces S11 and S12 may include at least one of surface inclined from the effective region of the object-side surface to the effective region of the sensor-side surface, a surface inclined from the effective region of the effective region to the rib region of the sensor-side surface, or a surface inclined from the rib region of the object-side surface to the effective region of the sensor-side surface, on one side or both sides of the first direction Y. That is, the effective region of at least one of the object-side surface and the sensor-side surface of the at least one lens may be obliquely cut.

As shown in FIG. 6(A), the inclined side surfaces S11 and S12 of the first lens 111 may have an outer edge S111 in the second direction X in a curved shape. The inclined side surfaces S11 and S12 of the first lens 111 may gradually decrease in width in the second direction X from the object-side first surface S1 to the second surface S2. FIGS. 4 and 6(B), the outer surface S10 of the first lens 111 is provided as a surface except for the inclined side surfaces S11 and S12 perpendicular to the optical axis direction Z, or the ribs of the outer surface S10 may be arranged in multiple stages.

In at least the first lens 111 of the plurality of lenses of an embodiment of the invention, a length A1 in the first direction Y of the first surface S1 and a length in the first direction Y of the second surface S2 are different from each other, a length A1 of the first surface S1 in the first direction Y may be shorter than the length B2 of the first surface S1 in the second direction X. Accordingly, a path of the light reflected through the inclined side surfaces S11 and S12 of the first lens 111 is changed, so that the light does not travel toward the image sensor 190 and a size of the unnecessary light incident on the image sensor may be minimized.

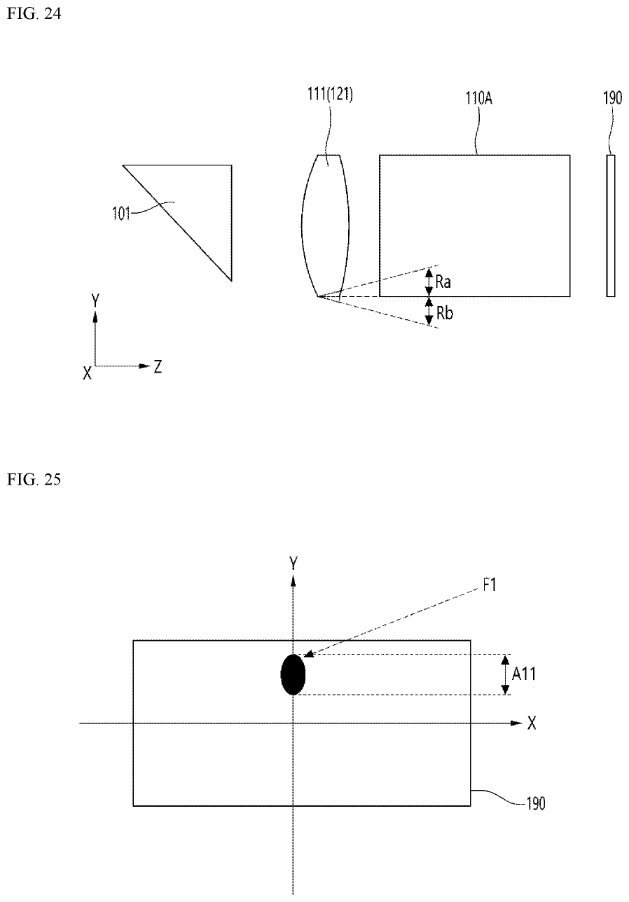

As shown in FIG. 21(A), when the light reflected by the inclined side surface Sa1 of the object-side lens 151 from the two adjacent lenses 151 and 152 travels to the effective region of the sensor-side lens 152, a miscellaneous light may be formed on the image sensor. In this case, the side surface Sa1 may be provided as a side surface parallel to the optical axis. As shown in FIG. 21(B), the light reflected by the inclined side surface Sa2 of the object-side lens 153 from the two adjacent lenses 153 and 154 goes out of the effective region (e.g., lower region) of the sensor-side lens 154. In this case, the miscellaneous light is not formed on the image sensor. The side surface Sa2 at this time may be provided as an inclined side surface (e.g., S11 and S12 in FIG. 2) that is not parallel to the optical axis, for example, the angle Rb of the inclined side surface may be 10 degrees or less, for example, in the range of 0.5 degrees to 10 degrees or in the range of 5 degrees to 10 degrees with respect to the optical axis as shown in FIG. 24. In order to form the inclined side surface Sa2 as shown in FIG. 21(B) on the object-side lens 153, the length in the first direction must be smaller than that of the sensor-side surface of the object-side surface. As shown in FIG. 21(C), the light reflected by the inclined side surface Sa3 of the object-side lens 155 from the two adjacent lenses 155 and 156 goes outside the effective region (e.g., upper region) of the sensor-side lens 156. In this case, the miscellaneous light is not formed on the image sensor. In this case, the side surface Sa3 may be provided as an inclined side surface that is not parallel to the optical axis, and for example, the angle Ra of the inclined side surface may be 10 degrees or less, for example, in the range of 0.5 degrees to 10 degrees, or in the range of 5 degrees to 10 degrees with respect to the optical axis. In order to form the inclined side surface Sa3 as shown in FIG. 21(C) on the object-side lens 155, a length of the sensor-side surface in the first direction is smaller than a length of the object-side surface in the first direction, and a difference in length between the object-side surface and the sensor-side surface may be greater than a difference in length between the two side surfaces shown in FIG. 21(B). Here, when the angle Ra is a positive (+) angle with respect to the optical axis, the angle Rb may be a negative (−) angle. In the invention, the angle of the inclined side surface of the first lens may be in the range of 5 degrees to 10 degrees or −5 degrees to 10 degrees with respect to the optical axis.

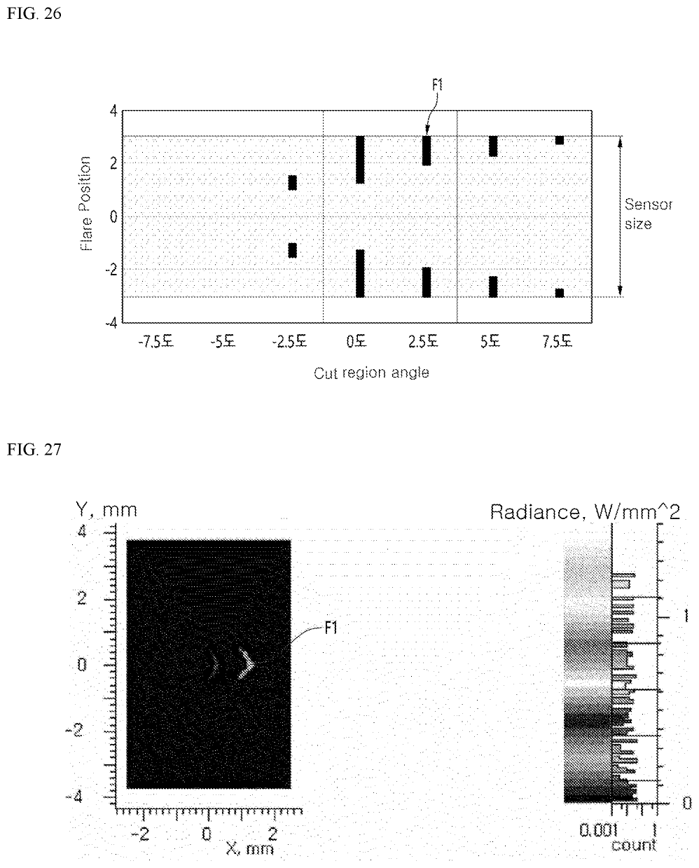

Here, referring to FIGS. 25 and 26 and Table 1 below, the flare positions in the image sensor according to the inclined cutting angle of the side surface of the first lens are shown in Table 1. FIG. 26 shows a region or position where the flare is formed on the image sensor according to the cutting angle of the lens. Table 1 shows this in a table.

TABLE 1

| | Cut angle | | | | | | |
|---|---|---|---|---|---|---|---|
| Position of flare | −7.5 | −5 | −2.5 | 0 | 2.5 | 5 | 7.5 |

| | | | | | |
|---|---|---|---|---|---|
| \| Max \| | 1.5 | 3 | 3 | 3 | 3 |
| \| Min \| | 1 | 1.3 | 2 | 2.3 | 2.7 |

Here, the cut positive angle is the angle Ra with respect to the optical axis, and the negative angle is the angle Rb with respect to the optical axis. In FIG. 25, A11 is the size of the flare F1 on the image sensor 190, and it may be seen that the flare is reduced or removed as the absolute value of the angle of the cut side increases. However, when the cut angle increases indefinitely, the height of the camera module increases according to Table 2. Therefore, considering both the flare removal effect and the height of the lens, it is most appropriate for the angle of the cut side surface to be in the range of 5 to 10 degrees or −10 to −5 degrees with respect to the optical axis. In this case, the cut angle (As the absolute value) increases, the height of the first lens may be increased as shown in Table 2 to reduce flare.

TABLE 2

| | Increase in the height of |
|---|---|
| Angle of cut side surface | the camera module (mm) |
| \| 5 \| | 0.17 |
| \| 10 \| | 0.35 |
| \| 15 \| | 0.54 |
| \| 20 \| | 0.73 |
| \| 25 \| | 0.93 |

Therefore, for the first lens 111 having the inclined side surfaces S11 and S12, since a length of the first direction Y of the sensor-side surface is cut longer than a length of the first direction Y of the object-side surface by the angle R1 of the cut side surfaces S11 and S12, a difference in lengths in the first direction Y of the object-side surface and the sensor side surface reduce, the cutting region of the effective region may be minimized, and the height of the lens may be reduced. Comparing the size of the miscellaneous light of the invention of FIG. 28(A) with the comparative example of FIG. 27(A), it may be seen that the size of the miscellaneous light on the image sensor in the optical system of the comparative example is larger than that of the invention, As shown in FIG. 28(B), it may be seen that the illuminance distribution of the invention is more uniform than the illuminance distribution of the comparative example of FIG. 27(B).

When explaining at the effective diameters of the second to fifth lenses 112, 113, 114, and 115 in the optical system, the effective diameter of the third surface S3 of the second lens 112 is smaller than the effective diameter (i.e., B2) of the first surface S1, may be less than or equal to 4 mm or may be in the range of 4.5 mm to 5 mm, and may be equal to or greater than the effective diameter of the fourth surface S4. The effective diameter of the fourth surface S4 may be 4 mm or less, for example, in the range of 4.5 mm to 4 mm. Effective diameters of the fifth and sixth surfaces S5 and S6 of the third lens 113 may be larger than the effective diameters of the third and fourth surfaces S3 and S4 of the second lens 112. The effective diameter of the fifth surface S5 may be the same as or larger than the effective diameter of the sixth surface S6, and may be 4.2 mm or less, for example, in the range of 3.7 mm to 4.2 mm. The effective diameter of the sixth surface S7 may be 4.17 mm or less, for example, in the range of 3.7 mm. to 4.17 mm. Effective diameters of the seventh and eighth surfaces S5 and S6 of the fourth lens 114 may be smaller than the effective diameters of the fifth and sixth surfaces S7 and S8 of the third lens 113. The effective diameter of the seventh surface S7 may be equal to or larger than the effective diameter of the eighth surface S8, and may be 3.3 mm or less, for example, in the range of 2.9 mm to 3.1 mm. The effective diameter of the eighth surface S8 may be 3.27 mm or less, for example, in the range of 2.85 mm to 3.27 mm. The effective diameters of the ninth and tenth surfaces S9 and S10 of the fifth lens 115 may be larger than the effective diameters of the seventh and eighth surfaces S7 and S8 of the fourth lens 114. the effective diameter of the ninth surface S9 may be smaller than the effective diameter of the tenth surface S10, and may be 3.5 mm or less, for example, in the range of 2.8 mm to 3.5 mm, and the effective diameter of the tenth surface S10 may be 4.2 mm or less, for example, in the range of 3.7 mm to 4.2 mm. The tenth surface S10 may diffuse the light incident through the ninth surface S9 to uniformly irradiate the light from the center to the peripheral region of the image sensor 190 through the optical filter 192.

When explaining at the relative refractive index at 940 nm of the lens in the optical system, the first lens 111 has a lower refractive index than that of the second lens 112, and may be less than 1.6. The second lens 112 has a higher refractive index than that of the first lens 111, and may be 1.57 or more. The third and fourth lenses 113 and 114 have a lower refractive index than that of the second lens 112, and the difference between the two refractive indices may be at most 0.1 or less. The fifth lens 115 may have a higher refractive index than that of the fourth lens 114, and may be 1.6 or more, for example, 1.65 or more. The fifth lens 115 has a refractive index higher than the refractive indices of the first to fourth lenses 111, 112, 113, and 114, and thus may effectively refracting light.

When explaining at the Abbe number in the d-line (e.g., 587 nm) of the lens in the optical system, the Abbe number of the first lens 111 may be greater than the Abbe number of the second lens 112, for example, 1.7 times or more. The Abbe number of the second lens 112 may be smaller than the Abbe numbers of the first lens 111 and the third lens 113, for example, may be 30 or less. The Abbe number of the third lens 113 may be 50 or more. The Abbe numbers of the first, third, and fourth lenses 111, 113, and 114 may be 50 or more, and may be equal to each other. The difference between the Abbe numbers between the third lens 113 and the fourth lens 114 may be no or less than 5. The Abbe number of the fifth lens 115 may be smaller than the Abbe number of the fourth lens 114, and a difference from the Abbe numbers of the second lens 112 and the fifth lens 115 may be 10 or less. The Abbe number of the second lens 112 may be the smallest among the lenses of the optical system, and may be smaller than the Abbe number of the second lens 112 and may be 25 or less.

Abbe numbers in the lenses 111, 112, 113, 114 and 115 are decreased when the refractive index of the lenses is increased. When the Abbe number is small, color dispersion is effective, and when the Abbe number is large, color dispersion may occur less. When the Abbe numbers in the lenses 111, 112, 113, 114, and 115 is high, chromatic aberration may be small and transparency may be improved, and when the Abbe number is low in the lenses 111, 112, 113, 114, and 115, chromatic aberration may be high and distortion around the center of the lens may be increased.

In the optical system according to an embodiment of the invention, an angle of the half field of view (HFOV) may be 12 degrees or less, for example, in the range of 5 degrees to 12 degrees. In the optical system, the distance from the center of the image sensor 190 to the end in the diagonal direction may be 3 mm or less, for example, in the range of 2 mm to 3 mm. In addition, the wavelength of the light beam used in the optical system may be in the range of 870 nm to 1000 nm. The MTF degradation may be 10% or less in a temperature range from a low temperature (e.g., −40° C.) to a high temperature (e.g., 85° C.).

In the optical system according to an embodiment of the invention, the material of the lens barrel or the lens holder supporting the lenses may be a metal material, for example, a metal having high heat dissipation characteristics. Accordingly, even when a lens made of a plastic material is used in the optical system, a decrease in heat dissipation efficiency may be prevented.

Table 3 shows the lens characteristics of the optical system according to the embodiment of the invention.

TABLE 3

| First | | Surface | Thickness/ | | |
|---|---|---|---|---|---|
| embodiment | Surface # | type | Distance | Index | Abbe# |
| First lens | S1 | ASP | 1.80 | 1.52 | 56.0 |
| | S2 | ASP | 1.5 | | |
| Second lens | S3 | ASP | 0.30 | 1.61 | 25.9 |
| | S4 | ASP | 0.10 | | |
| third lens | S5 | ASP | 0.140 | 1.53 | 56.0 |
| | S6 | ASP | 0.43 | | |
| fourth lens | S7 | ASP | 0.46 | 1.52 | 56.0 |
| | S8 | ASP | 0.74 | | |
| Fifth lens | S9 | ASP | 1.80 | 1.66 | 20.4 |
| | S10 | ASP | 4.2 | | |
| Filter | FS1 | SPH | 0.110 | 1.52 | 64.20 |
| | FS2 | SPH | 0.452 | | |
| Image sensor | Image | SPH | 0.000 | | |

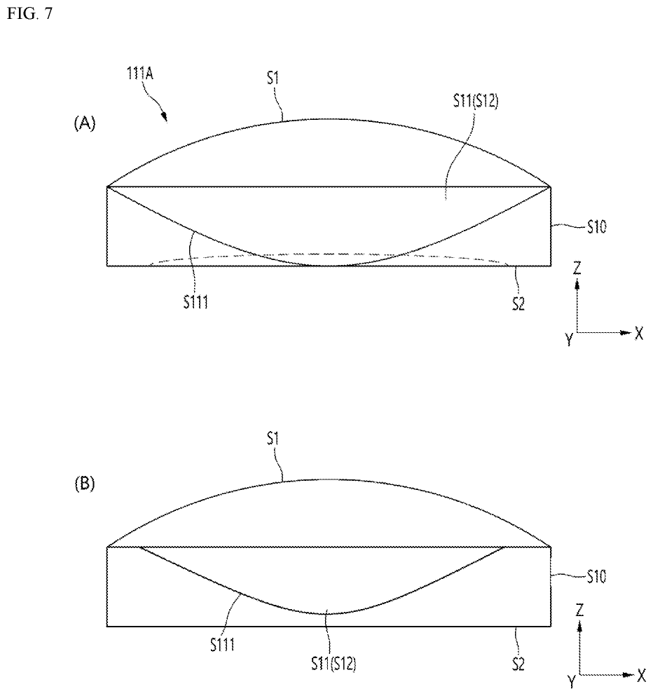

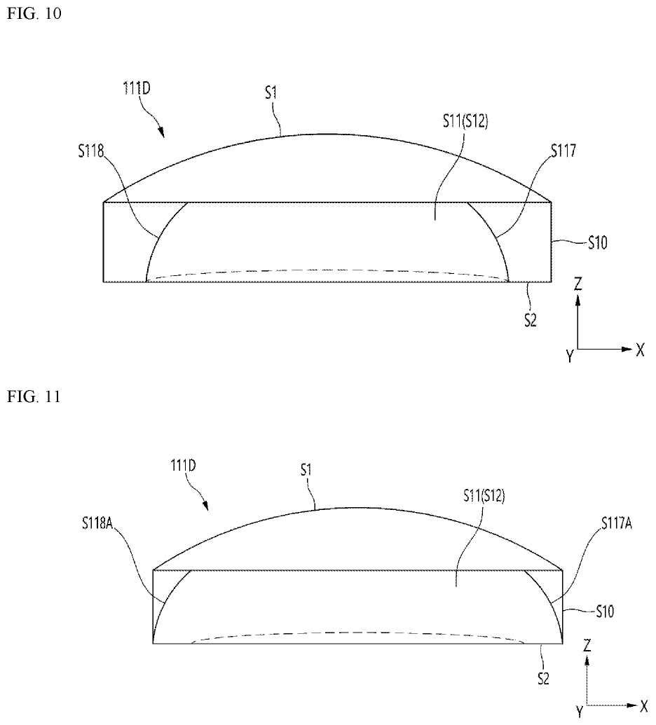

In Table 3, the ASP indicates an aspherical surface, and in the items of each surface S1 to S10, the thickness indicates the thickness (unit, mm) of each lens on the optical axis, and the distance indicates an interval between the two lenses aligned on the optical axis (unit, mm) is indicated. The thickness of FS1 is the thickness of the filter. FIGS. 7 to 13 are modified examples of the first lens.

Referring to FIG. 7(A), the inclined side surfaces S11 and S12 of the first lens 111A may have the same maximum length as the effective diameter of the first surface S1 in the second direction X, and an outer edge S111 in the second direction on the inclined side surfaces S11 and S12 may be extend from the edge of the first surface S1 to the edge of the second surface S2 in a curved shape. Referring to FIG. 7(B), the inclined side surfaces S11 and S12 of the first lens have a maximum length in the second direction X that is smaller than the effective diameter of the first surface S1, and an outer edge S111 of the inclined side surfaces S11, S12 in the second direction may be extend from the edge of the first surface S1 to the inside edge (i.e., a position close to the center of the inclined side surface) of the second surface S2 in a curved shape. As shown in FIG. 7(A) (B), in the inclined side surfaces S11 and S12, the maximum linear distance in the optical axis direction may be equal to or shorter than the height of the outer side surface S10 of the first lens 111.

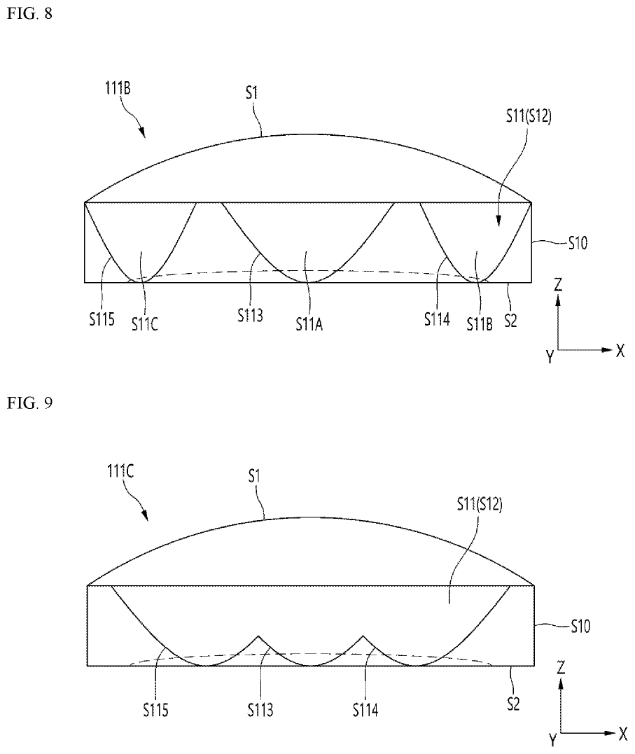

As shown in FIG. 8, when the inclined side surfaces S11 and S12 of the first lens 111B are viewed in the first direction Y, at least two or more, for example, a plurality of regions S11A, S11B, and S11C may be separated from each other, and each of the regions S11A, S11B, and S11C may have outer edges S113, S114, and S115 formed in a hemispherical shape. The outer edges S113, S114, and S115 may be curved from the edge of the first surface S1 to the edge of the second surface S2, or may be disposed from the edge of the first surface S1 to an inside (i.e., closer to the center of the inclined side surface) of the edge the second surface S2.

As shown in FIG. 9, when the inclined side surfaces S11 and S12 of the first lens 111C are viewed in the first direction Y, at least two or more, for example, a plurality of regions may be formed to be connected to each other, and the edges S113, S114, and S115 of the regions connected to each other may be formed in a shape in which hemispherical shapes overlap. The outer edges S113, S114, and S115 are curved from the edge of the first surface S1 to the edge of the second surface S2, or may be disposed from the edge of the first surface S1 to an inside (i.e., closer to the center of the inclined side surface) of the edge the second surface S2.

As shown in 10, the inclined side surfaces S11 and S12 of the first lens 111D may have a maximum length in the second direction X that is smaller than the effective diameter of the first surface S1, and the length of the second direction X in the inclined side surfaces S11 and S12 may be the minimum at the edge of the first surface S1 and may be the maximum at the edge of the second surface S2. In this case, the effective region of both the first and second surfaces S1 and S2 may be cut, and may be cut at the inclined angle Ra of FIG. 24. The second direction outer edges S117 and S118 of the inclined side surfaces S11 and S12 are edges of the cut side and may be connected from the edge of the second surface S2 to the edge of the first surface S1.

As shown in FIG. 11, in the inclined side surfaces S11 and S12 of the first lens 111D, the maximum length in the second direction X may be equal to the diameter of the second surface S2, and the length of the second direction X in the inclined side surfaces S11 and S12 may be the minimum at the edge of the first surface S1 and may be the maximum at the edge of the second surface S2. In this case, the effective region of both the first and second surfaces S1 and S2 may be cut, and may be cut at the inclined angle Ra of FIG. 24. The second direction outer edges S117A and S118A of the inclined side surfaces S11 and S12 are edges of the cut side and may be connected from the edge of the second surface S2 to the edge of the first surface S1.

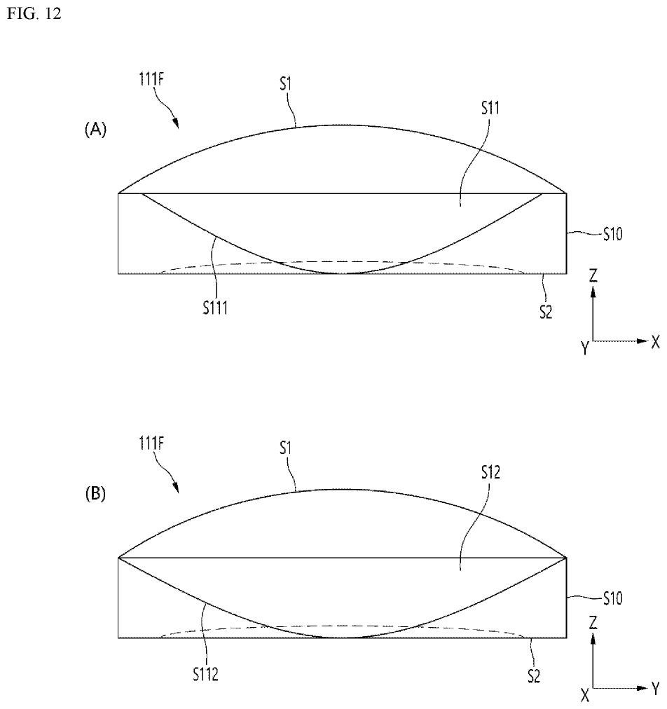

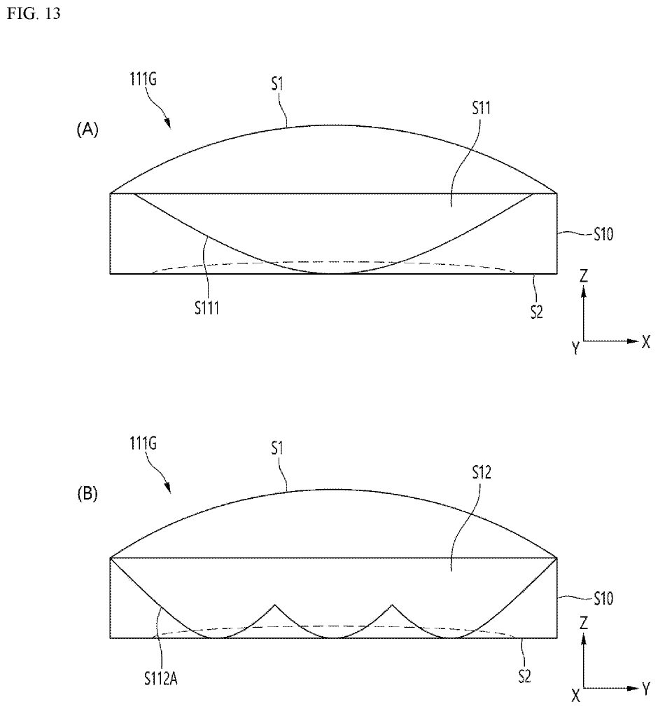

According to an embodiment of the invention, the area, size, or shape of the inclined first side surface S11 and the second side surface S12 may be different with respect to the first lens. For example, as shown in FIG. 12(A)(B), the area of the first side surface S11 and the second side surface S12 are different examples, and the area of the first side surface S11 may be smaller than the area of the second side surface S12. As shown in FIG. 13(A)(B), the first side surface S11 and the second side surface S12 may have a different shape or/and different area, the inflection point of the curve of the second side surface S12 may be more than the inflection point of a curve of the first side surface S11. In addition to, the area of the second side surface S12 may be larger than the area of the first side surface S11.

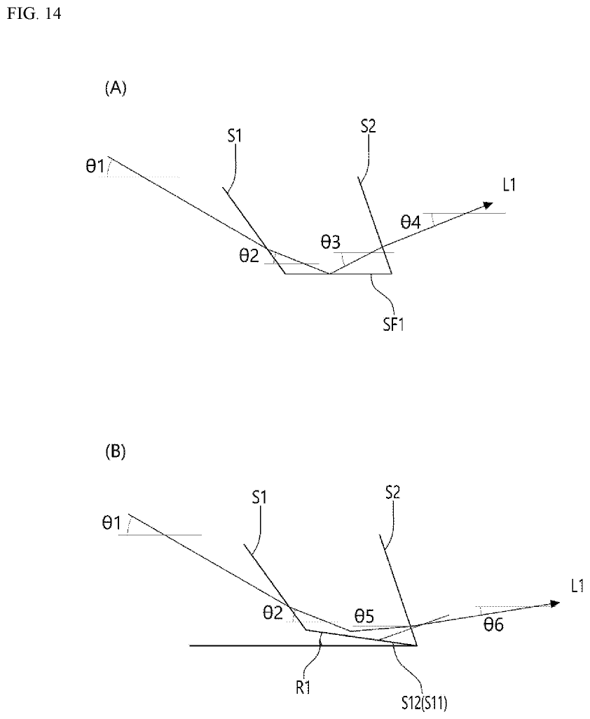

FIG. 14(A) is a case in which the first lens of the comparative example has a flat side surface SF1, and FIG. 14(B) is a case in which the first lens of the invention has inclined side surfaces S11 and S12. In FIG. 14(A)(B), the angle θ1 incident on the first surface, the incident and reflection angles θ2 and θ5 on the side surfaces SF1, S11, and S12, and the exit angles θ4 and θ6 from the second surface S2 are compared with Table 4 as follows.

TABLE 4

| SF1 | θ1 | θ2 | θ3 | θ4 |
|---|---|---|---|---|
| Angle range | 0~30 | ~−15 | −15~0 | 15~0 |
| S11(S12) | θ1 | θ2 | θ5 | θ6 |
| Angle range | 0~30 | 0~15 | 15~0 | −5~5 |

Here, when reflected at an angle θ5 by the inclined side surfaces S11 and S12 of the first lens 111 and exited at angle θ6 through the second surface S2, in order for the exit angle θ6 to travel out of the effective region of the other lens, the angle θ6 always travels outside the effective region when it is a positive (+) angle, and when it is a negative (−) angle, the smaller the value of the exit angle, the greater the effect of the removing miscellaneous light. Here, Table 3 is an example in which the inclined side surfaces S11 and S12 are measured at an angle of 7.5.

FIGS. 15 to 17 are views illustrating another example of the first lens of FIG. 2.

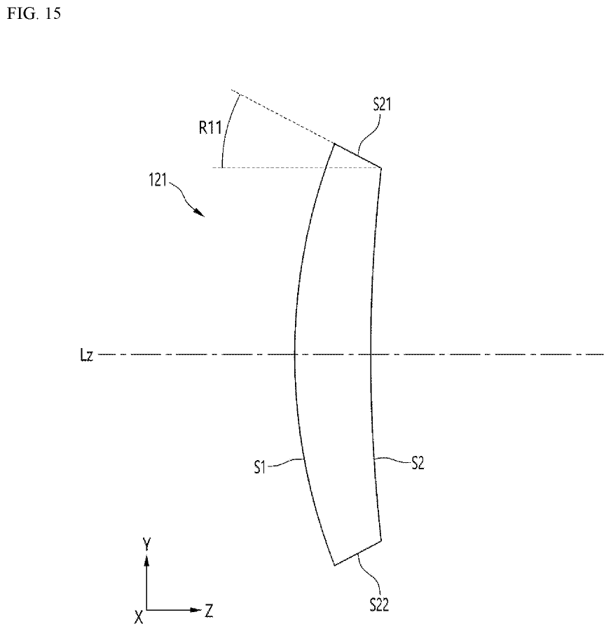

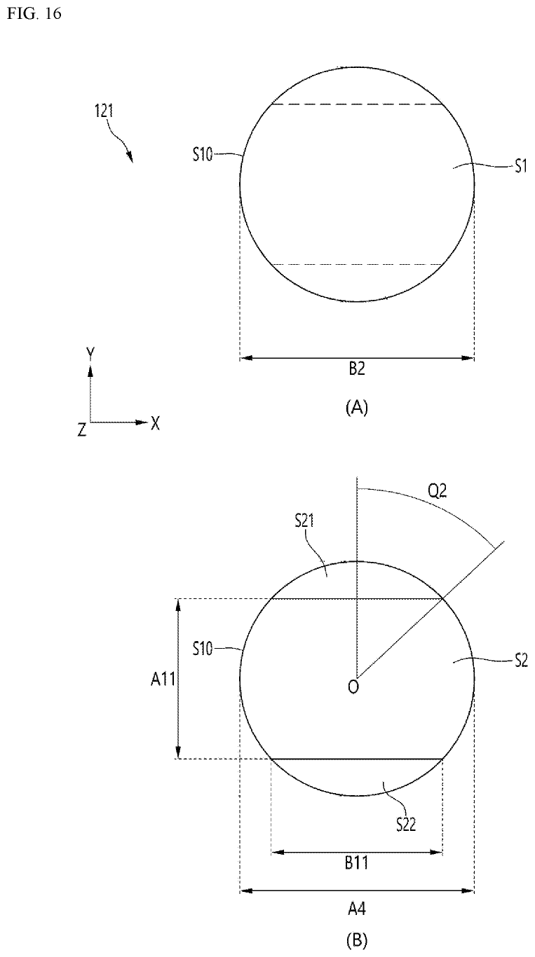

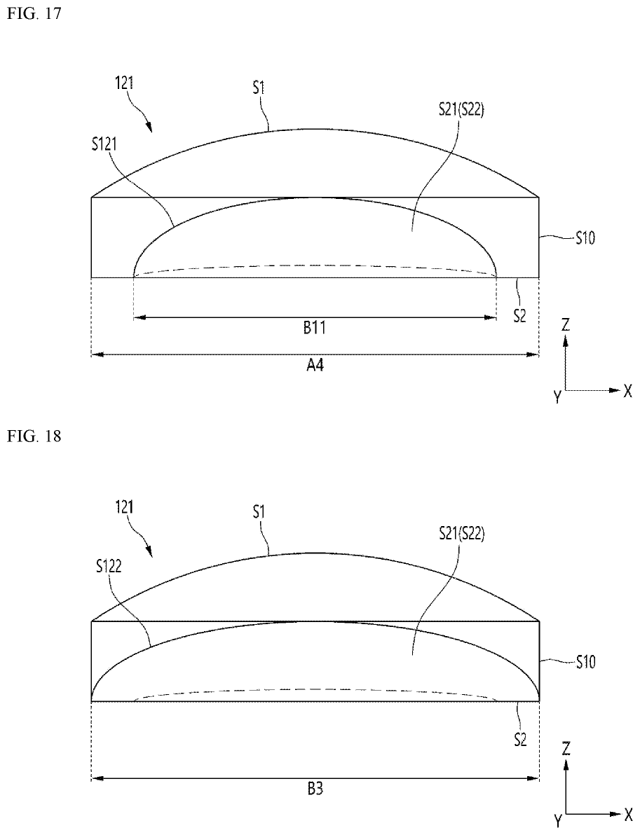

Referring to FIGS. 15 to 17, the first lens 121 may include side surfaces S21 and S22 inclined with respect to an axis parallel to the optical axis Lz. The inclined side surfaces S21 and S22 may be inclined at a predetermined angle R11 with respect to an axis parallel to the optical axis. The angle R11 may be 10 degrees or less, for example, in the range of 0.5 to 10 degrees, or in the range of 5 to 10 degrees. As shown in FIG. 16, the lengths B2 of the first surface S1 of the first lens 121 in the first and second directions Y and X are equal to each other, and the lengths A11 and A4 of the second surface S2 the first and second directions Y and X may be different from each other. The first direction length A11 of the second surface S2 may be smaller than the second direction length A4, and may be smaller than the length B2 of the first surface S1 in the first and second directions Y and X. An angle Q2 between the straight line in the first direction Y passing through the center O and the upper ends of the first and second side surfaces S21 and S22 with respect to the center O of the first lens 121 may cover the half region of the length B11 and may be less than or equal to 60 degrees, for example, in the range of 30 degrees to 60 degrees or in the range of 30 degrees to 50 degrees. The angle Q2 indicates a position where the first and second side surfaces S11 and S12 start from the sensor side surface of the first lens. As shown in FIG. 17, the first and second side surfaces S21 and S22 are cut obliquely from the edge of the second surface S2 toward the edge of the first surface S1, and the edges S121 of the first and second side surfaces S21 and S22 may be formed in a curved shape. On both sides of the first lens 121 in the first direction Y, there is one or a plurality of surfaces cut as in the first and second side surfaces S21 and S22, or the maximum linear distance (optical axis direction distance) from the first surface S1 to the second surface S2 in the first and second side surfaces S21 and S22 may be equal to or smaller than the height of the outer surface S10 of the first lens 121.

As shown in FIGS. 17 and 18, the first and second side surfaces S21 and S22 of the first lens 121 may have a maximum distance in the second direction X on the edge of the second surface S2, and have the minimum distance on the edge of the first surface S1. The maximum distance in the second direction X may be equal to or smaller than the diameter of the first lens 121.

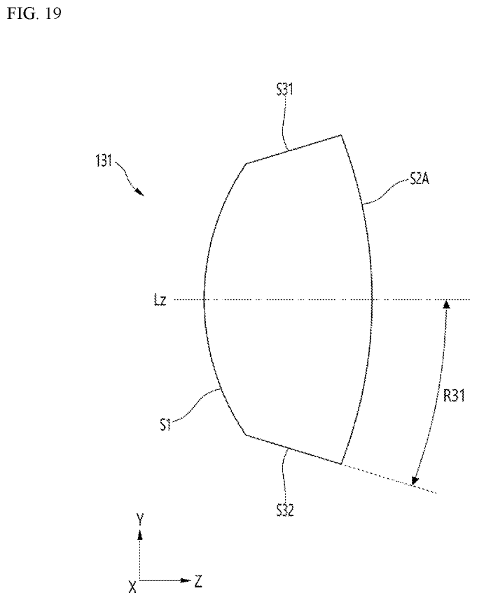

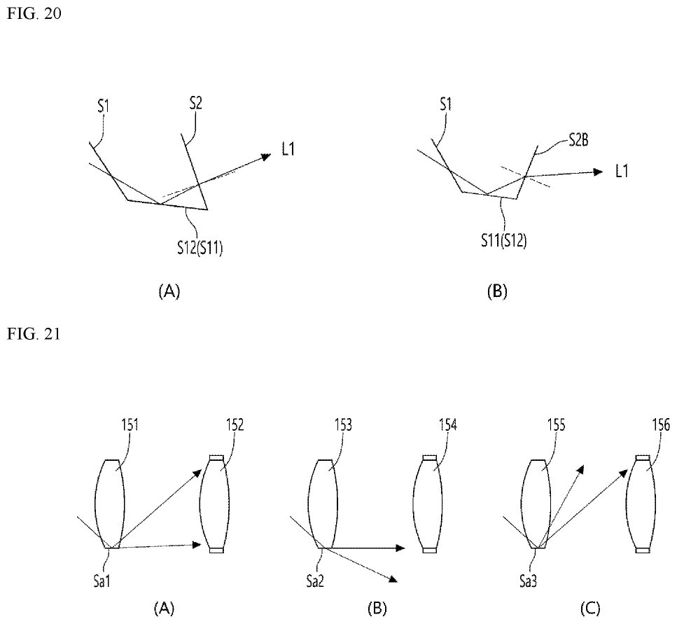

As shown in FIG. 19, the first surface S1 of the first lens 131 may be convex, and the second surface S2A may be convex, and may include an aspherical surface. The side surfaces S31 and S32 inclined from the first surface S1 of the first lens 131 toward the second surface S2A and disposed on both sides of the first lens 131 in the first direction Y may be inclined a predetermined angle R31. The angle R31 may be 10 degrees or less, for example, in the range of 0.5 to 10 degrees, or in the range of 5 to 10 degrees. When the angle R31 is larger than the above range, the height of the camera module increases, and when the angle R31 is smaller than the above range, the effect of reducing flare is insignificant. As shown in FIG. 20, when the second surface S2 of the first lens is concave (FIG. 20(A)) and when the second surface S2B is convex (FIG. 20(B)), the path of the emitted light L1 may be different. At this time, the path in which light is refracted by the convex second surface S2B as shown in FIG. 20(B) is more effective in removing the flare than the light path in which light is refracted by the concave second surface S2 as shown in FIG. 20(A).

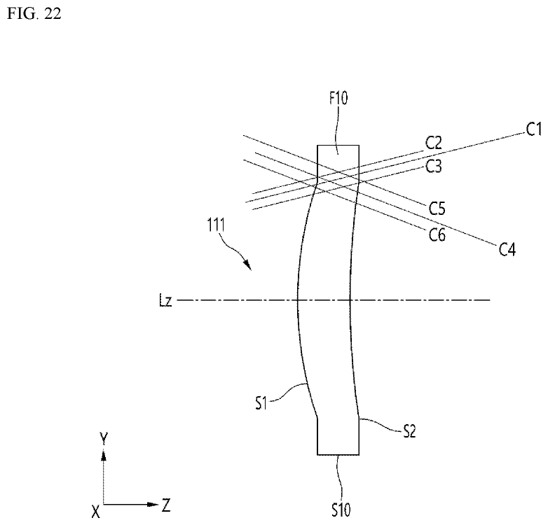

FIG. 22 illustrates examples of lines cut on one side or both sides of the first lens 111 in the first direction Y in the invention. As shown in FIG. 22, when the outer rib F10 of the first lens 111 is connected to the outside of the effective region of the first and second surfaces S1 and S2, the first cutting line C1 is cut toward the rib of the second surface S2 from the effective region of the first surface S1, the second cutting line C2 is cut toward the rib of the second surface S2 at the boundary between the effective region and the rib of the first surface S1, and the third cutting line C3 may be cut from the effective region of the first surface S1 to the boundary between the effective region of the second surface S2 and the rib. Conversely, the fourth cutting line C4 is cut from the effective region of the second surface S2 toward the rib of the first surface S1, and the fifth cutting line C5 is cut from the boundary between the effective region of the second surface S2 and the rib toward the rib of the first surface S1, and the sixth cutting line C6 is cut from the effective region of the second surface S2 to the boundary between the effective region of the first surface S1 the rib. In order to control a path for the light incident from the first lens 111, at least one of the first and second surfaces S1 and S2 may be provided as a surface with the lines C1, C3, C4, and C6 in which an effective region is cut. The inclination angle of the cut lines may be 10 degrees or less with respect to the optical axis, for example, in the range of 0.5 to 10 degrees or in the range of 5 to 10 degrees. When it is small, the effect of reducing flare is insignificant. When the cutting line is located inside the lens with respect to the optical axis, the angle of the inclined side surface is a positive value, and when the cutting line is located on the outside, the angle of the inclined side surface may be divided into a negative value. In this case, the angle of the cut side surface by the cutting line C1, C3, C4, and C6 in the first lens 111 may be in the range of 5 to 10 degrees or −10 to −5 degrees with respect to the optical axis.

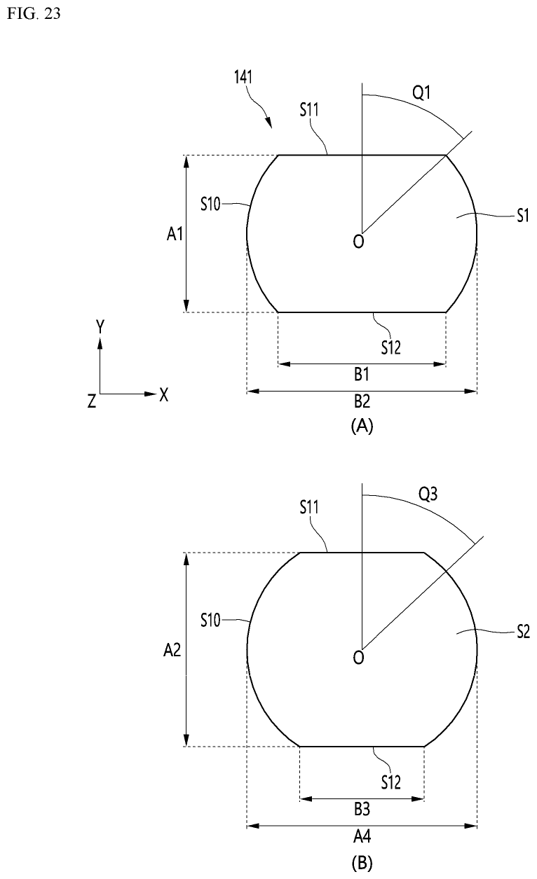

FIGS. 23(A)(B) is other examples of FIGS. 2 and 5, and are examples of the first and second surfaces cut along the cutting line C3 in FIG. 22. Referring to FIG. 23(A)(B), the length A1 in the first direction Y of the object-side first surface S1 in the first lens 141 may be smaller than the length B2 in the second direction X. In the first lens 141, the length A2 in the first direction Y of the sensor-side second surface S2 may be smaller than the length A4 in the second direction X, may be the same as or greater than the effective diameter of the second surface S2, and may be smaller than the diameter (e.g., B2) of the first surface S1. For example, the length A1 of the object-side first surface S1 in the first direction Y may be less than or equal to the length of the effective diameter of the first surface S1, and may be smaller than the length B2 in the second direction X. Lengths A2 and A4 of the sensor-side second surface S2 in the first and second directions Y and X are lengths including ribs, and may have a relationship of length A4>A2>A1. In the first lens 141, the effective diameter in the first and second directions Y and X of the object-side first surface S1 and in the first and second directions Y and X of the sensor-side second surface S2 may not be the same length. Here, the lengths A1 and A2 in the first direction Y may be the minimum straight-line distance between the side surfaces S11 and S12 cut on the first and second surfaces S1 and S2 of the first lens 141. The lengths B1 and B2 in the second direction X may have a relationship of length B2>B1 and the length B1 is the minimum length in the second direction X. Based on the center O of the first lens 141, a first angle Q1 between a straight line in the first direction Y passing through the center O and one end of the object side of the first side surface S11 may be greater than the second angle Q3 between a straight line in the first direction Y and one end of the sensor side of the first side surface S11, and may be 60 degrees or less, for example, in the range of 30 degrees to 60 degrees or in the range of 30 degrees to 50 degrees. The second angle Q3 may be 45 degrees or less, for example, in the range of 30 degrees to 45 degrees. The first and second angles Q1 and Q3 may indicate positions where the first and second side surfaces S11 and S12 start on the object side or the sensor side surface of the first lens 141. As shown in FIG. 24, the first lenses 111 and 121 closest to the prism 101 are provided as side surfaces inclined to one side or both sides in the first direction, and the lens unit 110A having four or more lenses is provided between the first lenses 111 and 121 and the image sensor 190.

As shown in FIG. 29, a camera module 711 having an optical system according to an embodiment may be coupled in a case 700 of a mobile terminal. In the camera module 711, a plurality of lens modules 712, 732, and 752 are arranged in a first direction and/or a second direction, and at least one or all of the lens modules 712, 732 and 752 may be vertically upward or downward. A ToF lens module 772 may be added or a camera flash module may be further disposed within the camera module 711, but is not limited thereto. A part of the camera module may protrude from the case 700 of the terminal. The optical system according to an embodiment of the invention may reduce the height of the camera module by cutting a part of the first lens 111. The optical system may change the light incident in a direction perpendicular to the surface of the terminal or the movable body applied including the reflective member 101 in a direction parallel to the surface of the movable body. Accordingly, the optical system including the plurality of lenses may have a thinner thickness in the terminal or the movable body, and thus the terminal or the movable body may be provided thinner.

Features, structures, effects, etc. described in the above embodiments are included in at least one embodiment of the invention, and are not necessarily limited to only one embodiment. Furthermore, features, structures, effects, etc. illustrated in each embodiment may be combined or modified for other embodiments by those of ordinary skill in the art to which the embodiments belong. Accordingly, the contents related to such combinations and modifications should be interpreted as being included in the scope of the invention. In addition, although the embodiment has been described above, it is only an example and does not limit the invention, and those of ordinary skill in the art to which the invention pertains are exemplified above in a range that does not depart from the essential characteristics of the present embodiment. It may be seen that various modifications and applications that have not been made are possible. For example, each component specifically shown in the embodiment may be implemented by modification. And the differences related to these modifications and applications should be construed as being included in the scope of the invention defined in the appended claims.

We claim:

1. An optical system, comprising:
a plurality of lenses arranged in a direction from an object side to a sensor side,
wherein at least one first lens of the plurality of lenses includes a first surface that is an object-side surface and a second surface that is a sensor-side surface,
wherein a length in a first direction of the first surface is different from a length in the first direction of the second surface,
wherein the length in the first direction of the first surface is shorter than a length in a second direction of the first surface,
wherein the first direction is orthogonal to an optical axis of the lenses,
wherein the second direction is perpendicular to the first direction and the optical axis, and
wherein the first surface has a non-circular shape, and the second surface has a circular shape.

2. The optical system of claim 1, wherein the first lens is a lens closest to the object side among the plurality of lenses, and
wherein the first surface has a convex shape, and the second surface has a concave shape.

3. The optical system of claim 1, wherein the first lens is a lens closest to the sensor side among the plurality of lenses.

4. The optical system of claim 1, wherein the length of the first surface in the first direction is shorter than a length in the first direction of the second surface.

5. The optical system of claim 4, wherein the first lens comprises a first side surface and a second side surface on both sides in the first direction, and
wherein at least one of the first side surface and the second side surface has an inclination with respect to the optical axis.

6. The optical system of claim 5, wherein an angle between at least one of the first side surface and the second side surface and the optical axis is 5 degrees to 10 degrees.

7. The optical system of claim 5, wherein the inclinations of the first side surface and the second side surface are equal to each other.

8. The optical system of claim 1, wherein the length in the second direction of the first surface is equal to a length in the first direction of the second surface.

9. The optical system of claim 1, wherein the length of the first surface in the first direction is longer than a length in the first direction of the second surface.

10. The optical system of claim 1, wherein a radius of curvature of the first surface is greater than a radius of curvature of the second surface.

11. The optical system of claim 5, wherein maximum lengths of the first and second side surfaces in the second direction are smaller than an effective length of the first surface and larger than an effective diameter of the second surface.

12. The optical system of claim 1, wherein the plurality of lenses includes first to fifth lenses, and
wherein the first lens has a positive refractive power.

13. The optical system of claim 12, wherein the first surface of the first lens has a convex shape, and the second surface has a concave shape.

14. The optical system according to claim 12, wherein a center thickness of the first lens is thicker than a center thickness of each of the second to fourth lenses.

15. The optical system of claim 12, comprising a reflective member disposed on the object-side surface of the first lens,
wherein the first lens is disposed between the reflective member and the second lens, and
wherein the fifth lens has a positive refractive power.

16. The optical system of claim 1, comprising a reflective member disposed on an object side of the plurality of lenses,
wherein the plurality of lenses includes first to sixth lenses,
wherein the first lens is disposed between the reflective member and the second lens,
wherein an object-side surface and a sensor-side surface of the sixth lens have different lengths in the first direction, and
wherein the length of the object-side surface of the sixth lens in the first direction is shorter than a length of the object-side surface in the second direction.

17. The optical system of claim 16,
wherein the fifth lens and the sixth lens move along the optical axis.

18. An optical system comprising:
a reflective member; and
first to fifth lenses disposed on a sensor side of the reflective member and arranged along an optical axis in a direction from an object side to the sensor side,
wherein the first lens is disposed between the reflective member and the second lens,
wherein the first lens has a positive refractive power,
wherein the first lens includes an object-side first surface and a sensor-side second surface,
wherein a length of the first surface in a first direction is different from a length of the second surface in the first direction,
wherein the length of the first surface in the first direction is shorter than a length of the first surface in the second direction,
wherein the first direction is orthogonal to the optical axis of the first to fifth lenses, and
wherein the second direction is orthogonal to the first direction and the optical axis.

19. The optical system of claim 18, wherein the first surface of the first lens has a convex shape, and the second surface has a concave shape, and
wherein the first surface has a non-circular shape, and the second surface has a circular shape.

20. The optical system of claim 18, wherein the length of the first surface in the first direction is shorter than the length of the second surface in the first direction,
wherein the first lens includes a first side surface and a second side surface on both sides in the first direction,
wherein the first side surface and the second side surface have an inclination with respect to the optical axis,
wherein an angle between each of the first and second side surfaces and the optical axis is 5 degrees to 10 degrees, and
wherein maximum length of the first and second side surfaces in the second direction is smaller than an effective length of the first surface and larger than an effective diameter of the second surface.
